(19) United States
(12) Patent Application Publication
(10) Pub. No.: US 2021/0193152 A1
(43) Pub. Date: Jun. 24, 2021

(54) Correlating Audio Signals For Authentication

(71) Applicant: 3M Innovative Properties Company, St. Paul, MN (US)

(72) Inventor: Monika Woszczyna, Pittsburgh, PA (US)

(21) Appl. No.: 17/250,285

(22) PCT Filed: Jul. 3, 2019
(86) PCT No.: PCT/IB2019/055655

§ 371 Date: Dec. 28, 2020

Related U.S. Application Data
(60) Provisional application No. 62/693,716, filed on Jul. 3, 2018.

(51) Int. Cl. G10L 17/06; G10L 25/06; G10L 17/18; G10L 17/24; G06F 21/32

(52) U.S. Cl. CPC G10L 17/06; G10L 25/06; G06F 21/32; G10L 17/24; G10L 17/18

(57) ABSTRACT

A computer system automatically authenticates a user to a server in response to determining that an audio signal received from one microphone positively correlates with an audio signal received from another microphone that is associated with a computing device at which the user is already authenticated to the server. Two audio signals are received from distinct microphones associated with first and second computing devices. A correlation module performs correlation on the two audio signals. An authentication module automatically authenticates a user to a server at the (first computing device if it is determined that the first audio signal positively correlates with the second audio signal and the user is already authenticated to the server at the second computing device.

### BACKGROUND

Physicians and other healthcare providers increasingly dictate medical information, such as by dictating medical reports during and after patient encounters. Such dictation may be performed using a stationary microphone, such as a microphone contained within or connected to a desktop computer, or a microphone mounted in a room. As another example, such dictation may be performed using a mobile microphone, such as a microphone contained within or connected to a smartphone, tablet computer, or laptop computer that the healthcare provider carries from location to location.

Such microphones typically capture the healthcare provider's speech and provide an audio signal representing that speech to software executing on a connected computing device. Such a computing device may either recognize the healthcare provider's speech locally or transmit the speech to a remote computer for speech recognition. In either case, the healthcare provider may need to log in to or otherwise be authenticated by the computing device, software, and/or account before dictating into the computing device. The requirement for authentication can impose a significant burden on the healthcare provider in the environments described above, in which the healthcare provider may rapidly move from one location to another and thereby need to or benefit from using microphones connected to a large number of different computing devices in a short period of time, thereby requiring the healthcare provider to stop and be authenticated at each such computing device before using that computing device for dictation.

What is needed, therefore, are improved methods and systems for enabling healthcare providers to benefit from the ability to dictate into a wide variety of stationary and mobile microphones without the authentication burden imposed by existing systems.

### SUMMARY

A computer system automatically authenticates a user to a server in response to determining that an audio signal received from one microphone positively correlates with an audio signal received from another microphone that is associated with a computing device at which the user is already authenticated to the server. Two audio signals are received from distinct microphones associated with first and second computing devices. A correlation module performs correlation on the two audio signals. An authentication module automatically authenticates a user to a server at the first computing device if it is determined that the first audio signal positively correlates with the second audio signal and the user is already authenticated to the server at the second computing device.

One embodiment of the present invention is directed to a method performed by at least one computer processor executing computer program instructions stored on at least one non-transitory computer-readable medium. The method includes receiving, at a correlation module, a first audio signal from a first device, the first device being associated with a first computing device; receiving, at the correlation module, a second audio signal from a second device, the second device being associated with a second computing device; at the correlation module, correlating the first audio signal and the second audio signal to produce correlation output; determining whether the correlation output satisfies a positive correlation criterion; and, in response to determining that the correlation output satisfies the positive correlation criterion: (1) identifying a user associated with the second audio signal; and (2) automatically authenticating the user associated with the second audio signal with a service via the second computing device.

Another embodiment of the present invention is directed to a system comprising at least one non-transitory computer-readable medium having computer program instructions stored thereon, wherein the computer program instructions are executable by at least one computer processor to perform a method. The method includes receiving, at a correlation module, a first audio signal from a first device, the first device being associated with a first computing device; receiving, at the correlation module, a second audio signal from a second device, the second device being associated with a second computing device; at the correlation module, correlating the first audio signal and the second audio signal to produce correlation output; determining whether the correlation output satisfies a positive correlation criterion; and, in response to determining that the correlation output satisfies the positive correlation criterion: (1) identifying a user associated with the second audio signal; and (2) automatically authenticating the user associated with the second audio signal with a service via the second computing device.

Other features and advantages of various aspects and embodiments of the present invention will become apparent from the following description and from the claims.

### BRIEF DESCRIPTION OF THE DRAWINGS

FIG. 1 is a dataflow diagram of a computer system for automatically authenticating a user at a first computing device by correlating audio signals received at the first computing device and a second computing device according to one embodiment of the present invention.

FIG. 2 is a flowchart of a method performed by the system of FIG. 1 according to one embodiment of the present invention.

FIG. 3 is a dataflow diagram of a computer system for automatically merging states of two computing devices in response to correlating audio signals from microphones associated with the two computing devices according to one embodiment of the present invention.

FIG. 4 is a flowchart of a method performed by the system of FIG. 3 according to one embodiment of the present invention.

### DETAILED DESCRIPTION

In general, embodiments of the present invention include systems and methods for correlating audio signals captured by a first (e.g., mobile) recording device and a second (e.g., stationary) recording device in order to automatically authenticate a user at the second recording device.

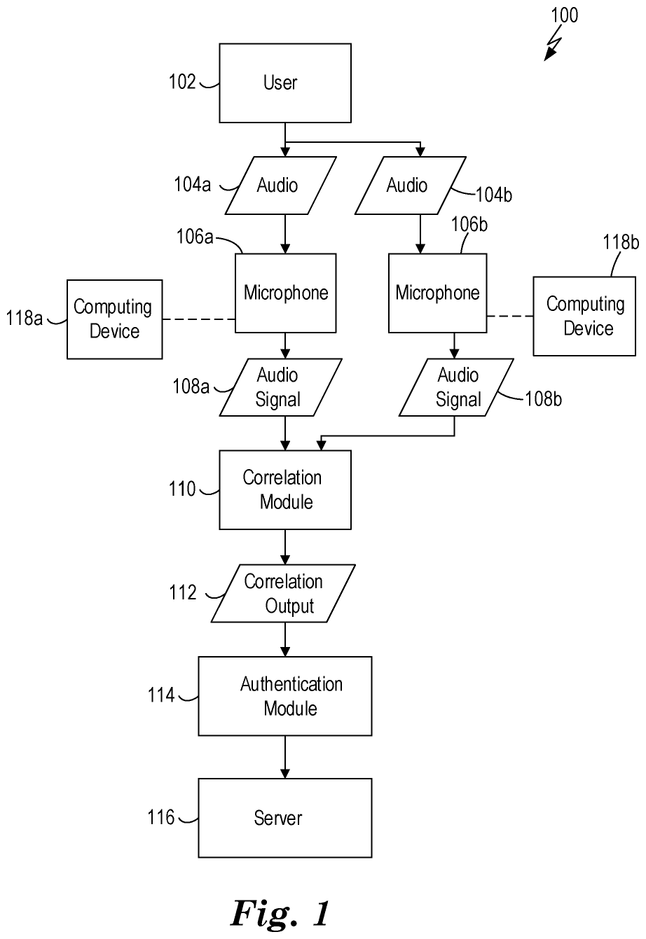

Referring to FIG. 1, a dataflow diagram is shown of a system 100 for correlating audio signals 108a and 108b generated as a result of capturing speech 104a-b of a user 102. For example, the system 100 may include a first microphone 106a and a second microphone 106b. For purposes of example, the first microphone 106a may be a mobile microphone, such as a microphone contained within or connected to a mobile recording device, such as a dedicated mobile recording device, a smartphone, a tablet computer, or a laptop computer; the second microphone 106b may be a stationary microphone, such as a microphone contained within or connected to a stationary recording device (e.g., a desktop computer) or a microphone that is mounted to a wall, counter, ceiling, or other surface or stationary object. Although the first and second microphones 106a-b are referred to herein as “mobile” and “stationary” microphones, respectively, for purposes of example, in practice either of the microphones 106a-b may be fixed or stationary. For example, both of the microphones 106a-b may be fixed, both of the microphones 106a-b may be stationary, or one of the microphones 106a-b may be fixed and the other one of the microphones 106a-b may be stationary.

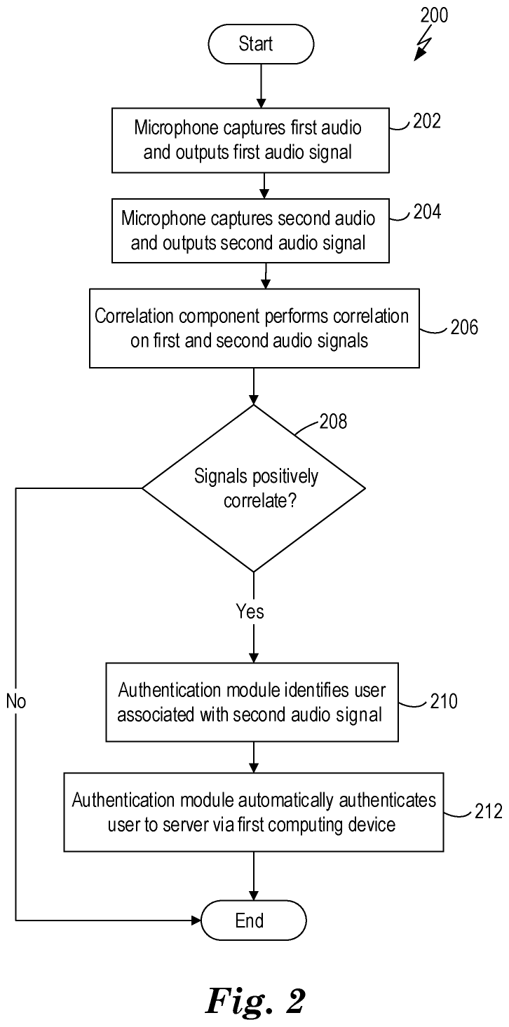

The microphone 106a may capture first audio 104a (e.g., speech of the user 102), and produce as output an audio signal 108a representing the audio 104a (FIG. 2, operation 202). The microphone 106b may capture second audio 104b (e.g., speech of the user 102), and produce as output an audio signal 108b representing the audio 104b (FIG. 2, operation 204). The audio 104a and the audio 104b may be any audio. In the particular example shown in FIG. 1, the speech 104a and 104b are the same speech as each other, in the sense that the user 102 may speak, and that the microphone 106a may capture that speech at substantially the same time and in substantially the same or similar location as the second microphone 106b captures that speech. For example, both of the microphones 106a-b may be in the same room as the user 102 at the same time. As a result, the audio signals 108a-b produced as output by the microphones 106a-b may be very similar to each other. In practice, the audio 104a-b that reaches the microphones 106a and 106b, respectively, may differ somewhat from each other, even if the audio 104a and 104b are produced by the same speech of the user 102. For this reason, and because it is not known a priori by the system 100 whether the audio 104a and 104b are the same as each other, and because the audio 104a and 104b may in fact not be the same as each other (e.g., one may be speech of the user 102 and the other may be speech of another user or ambient noise), the audio 104a and 104b are shown as distinct from each other in FIG. 1. In fact, one feature of embodiments of the present invention is to determine whether the audio 104a and 104b received by the microphones 106a and 106b, and as represented by the audio signals 108a and 108b, are the same as each other, even though this is not known a priori.

The system 100 includes a correlation module 110, which receives as input the audio signal 108a and the audio signal 108b. More generally, the correlation module 110 may receive, instead of or in addition to the audio signal 108a, an identifier of the user 102 and/or any feature derived from the audio signal 108a which allows the correlation module 110 to correlate the devices 118a-b. Similarly, the correlation module 110 may receive, instead of or in addition to the audio signal 108b, an identifier of the user 102 and/or any feature derived from the audio signal 108b which allows the correlation module 110 to correlate the devices 118a-b. The correlation module 110 performs correlation on the audio signal 108a and the audio signal 108b to produce correlation output 112 representing the result of the correlation (FIG. 2, operation 206). Any of a variety of correlation techniques may be used to perform this correlation. Such correlation techniques may include performing any computations which determine whether the audio 104a-b received by the microphones 106a-b are from the same source (e.g., the user 102), allowing for noise and distance between the speaker 102 and the different microphones 106a-b. Examples of such techniques include, but are not limited to, the following:
mathematical cross-correlation on the naked audio signals 108a-b;
comparison of features derived from the audio signals 108a-b, such as the local maximum of 20 log-mel coefficients 10 times per second, which would compress to a much lower bandwidth signal to compare than mathematical cross-correlation on the naked audio signals 108a-b, with much less effort on the correlation module 310; and
using a deep neural network (DNN) that has been trained to compute whether or not uploaded features (such as Mel coefficients) match based on what the DNN learned from training data from audio where the spoken audio 104a-b matched or did not match.

The correlation output 112 may represent the result of the correlation in any of a variety of ways. For the sake of simplicity and ease of explanation, the correlation output 112 will be described herein as a binary output, indicating either that the audio signals 108a-b positively correlate with each other or that they do not. The audio signals 108a-b are considered to positive correlate with each other if the correlation output 112 satisfies a positive correlation criterion. In practice, if the correlation output 112 satisfies a positive correlation criterion, this indicates, with a sufficiently high confidence (e.g., probability), that the audio 104a and the audio 104b are the same speech, which implies that the audio 104a and audio 104b likely were produced (e.g., spoken) by the same speaker (e.g., the user 102) at the same or substantially the same time as each other. Embodiments of the present invention may use of a variety of positive correlation criteria. One example of a positive correlation criterion is one which is satisfied if and only if a correlation value (e.g., the correlation output 112) is greater than a particular threshold. Various examples of techniques for calculating such a correlation value are described herein.

In FIG. 1, the correlation module 110 is shown as a standalone module. In practice, the correlation module 110 may be located in any of a variety of places, such as in the same recording device as the first microphone 106a, the same recording device as the second microphone 106b, or in a computing device (e.g., a server) that is distinct from the recording devices containing or connected to the first and second microphones 106a-b.

Although in the simple example of FIG. 1, the correlation module 110 only receives two audio signals 108a-b to correlate, in practice the correlation module 110 may receive any number of audio signals, such as hundreds or thousands of audio signals. In some embodiments, the correlation module 110 may perform correlation on all possible pairs of the audio signals it receives, resulting in n² correlations and corresponding correlation outputs, where n is the number of pairs of audio signals.

In some embodiments, the number of correlations is reduced in any of a variety of ways. For example, if the user 102 wishes for correlation to be performed on his or her speech, the user 102 may utter a predetermined cue phrase, such as “Good morning I'm John Smith” or “Authenticate me,” at the beginning of his or her speech. Any such cue phrase(s) may be used. The system 100 may be configured to perform automatic speech recognition on all of the audio signals it receives (e.g., the audio signals 108a-b) and to determine whether each of those audio signals begins with (or contains) a predetermined cue phrase. The system 100 may then only provide audio signals that were determined to contain such a predetermined cue phrase to the correlation module 110. As this implies, the system 100 may not provide audio signals not determined to contain such a predetermined cue phrase to the correlation module 110. As a result, the number of audio signal pairs n processed by the correlation module 110 may be reduced, potentially by a significant amount.

The system 100 includes an authentication module 114, which receives the correlation output 112 as input. In general, the authentication module 114 determines, based on the correlation output 112 (and possibly additional input, as described below) whether to authenticate the user 102, and then authenticates the user 102 if it is determines that the user 102 should be authenticated.

More specifically, assume that the user 102 is currently authenticated (e.g., logged in) to a server 116, which performs a service to the user 102, such as automatic speech recognition. The user 102 may, for example, currently be authenticated (e.g., logged in) to a service (e.g., application) executing on the server 116. Now assume that the first microphone 106a is contained within or otherwise connected to a computing device 118a, such as a smartphone or other mobile computing device, that the user 102 is logged into an account of the user 102 at the server 116 through the computing device 118a, and that this user 102 is the only user who is logged in to the server 116 through the computing device 118a connected to microphone 106a. Now assume that the correlation module 110 has determined that the audio signals 108a and 108b are positively correlated with each other (e.g., that the correlation module 110 has produced the correlation output 112, and that the correlation output 112 satisfies a positive correlation criterion indicating that the audio signals 108a and 108b are the same speech, which implies that the audio signals 108a and 108b were produced (e.g., spoken) by the same speaker (e.g., the user 102) at the same or substantially the same time as each other). In this case, and in response to determining that the audio signals 108a and 108b are positively correlated with each other (FIG. 2, operation 208), the authentication module 114 may: (1) determine that the audio signal 108a was received from the user 102 and that the user 102 is authenticated to the server 116 via the computing device 118a (FIG. 2, operation 210; (2) authenticate (e.g., log in) the user 102 to the server 116 automatically via the computing device 118b, such as by using the same credentials of the user 102 that were used to authenticate the user at the computing device 118a (FIG. 2, operation 212). As a result, the user 102 is authenticated to the server 116 via both the computing device 118a and 118b, without the need for the user 102 to manually authenticate (log in) via the computing device 118b.

In FIG. 2, operation 212, the authentication module 114 may, additionally or alternatively, authenticate (e.g., log in) the user 102 to the service to which the user 102 is already authenticated through the computing device 108a. If the user 102 is already authenticated to the server 116 before operation 212, then the authentication module 114 need not authenticate the user 102 to the server 116 again in operation 212, but instead may only authenticate the user 102 to the service (e.g., application) executing on the server 116. If, instead, the user 102 is not already authenticated to the server 116 before operation 212, then the authentication module 114 may, in operation 212, authenticate the user 102 to both the server 116 and the service executing on the server 116.

This method of authentication is ideally suited for use in two-factor authentication with biometric voiceprint. For example, assume that the user 102 is logged into an account of the user 102 at the server 116 via computing device 118a and that the system 100 correlates the audio 104a-b received at the two microphones 106a-b as described above to determine that the same user 102's speech is being received at both microphones 106a-b. Now that the system 100 has a reasonable certainty that the identity of the user 102 has been determined, the system may download the user 102's voiceprint from a known source and enable that voiceprint to be compared to incoming audio on any device (e.g., computing device 118a or 118b) in a two-factor authentication process. Furthermore, if two distinct users have been authenticated through one microphone, the system 100 may use the voiceprint of one or more of those users to disambiguate them from each other.

Although only one pair of audio signals 108a-b, generated at a particular time, is shown in FIG. 1, in practice the system 100 may repeatedly (e.g., continuously) receive and correlate received audio signals over time, and perform the method 200 of FIG. 2 on those audio signals to correlate them and then to automatically authenticate users in response to determining that audio signals received at one device positively correlate with audio signals received at another device.

Furthermore, the authentication module 114 may be used to automatically de-authenticate (log out) the user 102 from the server 116. For example, assume that the authentication module 114 had previously automatically authenticated the user 102 to the server 116 in response to determining that audio signals 108a and 108b positively correlated with each other. Now assume that the correlation module 110 correlates subsequently-received audio signals from devices 106a and 106b, and produces correlation output 112 indicating that the subsequently-received audio signals do not positively correlate with each other. The authentication module 114 may use its knowledge that the user 102 was previously automatically authenticated to the server 116 via the microphone 106b and its knowledge that a subsequent audio signal received from the microphone 106b does not correlate with a subsequent audio signal received from the microphone 106a to conclude that the user 102 is no longer in the vicinity of microphone 106a. In response to this determination, the authentication module 114 may automatically de-authenticate (log out) the user 102 from the server 116 at the device 106b. As a result, the user 102 is both automatically kept authenticated to the server 116 if and only if the microphone 106b is determined to be in the vicinity of the microphone 106a.

Although certain examples above involve automatically authenticating the user 102 at computing device 118b based on a previous authentication of the user 102 at computing device 118a, this is merely an example and does not constitute a limitation of the present invention. More generally, embodiments of the present invention may automatically authenticate the user 102 at either of the computing devices 118a-b in response to determining that the audio signals 108a-b correlate with each other. For example, the techniques described above may be used to authenticate the user 102 at computing device 118a in response to determining that the audio signals 108a-b correlate with each other, and based on a previous authentication of the user 102 at computing device 118b.

In one embodiment of the present invention, microphone 106a may be a Bluetooth microphone and microphone 106b may include a Bluetooth base station which accepts pairing requests, e.g., from the Bluetooth microphone 106a. Bluetooth pairing in general is unreliable to establish a shared context because of the long range of Bluetooth. For example, if the Bluetooth microphone 106a is in a different room than the Bluetooth base station 106b in this example, then conventional Bluetooth technology will not successfully pair the Bluetooth microphone 106a to the Bluetooth base station 106b, particularly if multiple Bluetooth base stations are in range of the Bluetooth microphone 106a. The techniques disclosed herein, however, may be applied in this situation to facilitate Bluetooth pairing of the microphone 106a and base station 106b by correlating audio received by the microphone 106a and base station 106b, and then performing Bluetooth pairing on the microphone 106a and base station 106b only if the audio correlation confirms that the same audio is being received by both the microphone 106a and base station 106b. More generally, if multiple stationary devices are in Bluetooth range of the mobile microphone 106a, then embodiments of the present invention may pair that microphone 106a with the Bluetooth base station which provides the best audio correlation with the microphone 106a.

Embodiments of the present invention have a variety of advantages. For example, the system 100 and method 200 automatically authenticate users to a server based on audio received from those users at multiple devices. The system 100 and method 200 effectively determine whether the audio 104a and 104b were received from the same source, e.g., the same user 102. This eliminates the need for users to authenticate themselves manually at many devices, particularly at stationary devices as they move from location to location. This provides significant benefits in environments, such as hospitals and other healthcare facilities, in which users are highly mobile and in which it is desirable to capture the speech of users through authenticated accounts as those users move from one location to another.

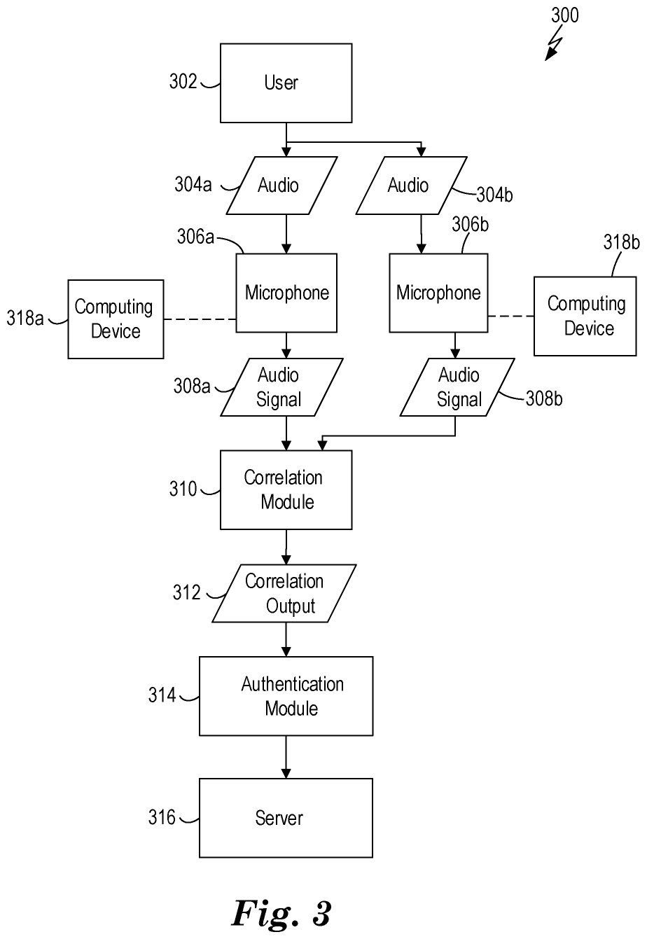

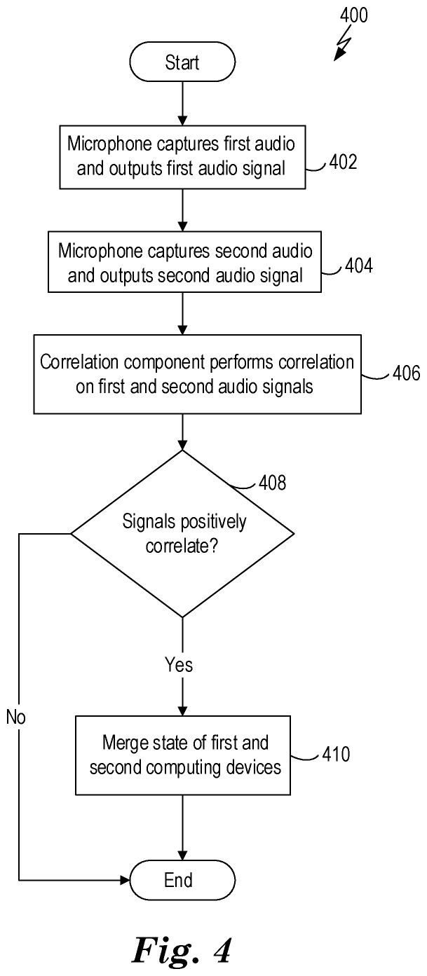

Having described certain particular embodiments of the present invention, other aspects of embodiments of the present invention will now be described. Referring to FIG. 3, a dataflow diagram is shown of a computer system 300 for automatically merging states of two computing devices in response to correlating audio signals from microphones associated with the two computing devices according to one embodiment of the present invention. Referring to FIG. 4, a flowchart is shown of a method 400 performed by the system 300 of FIG. 3 according to one embodiment of the present invention. Elements having the same reference numerals in FIG. 3 as in FIG. 1 refer to the same elements as those shown in FIG. 1. As a result, although such elements will not be described in detail in connection with FIG. 3, any description herein of such elements in connection with FIG. 1 is equally applicable to such elements in FIG. 3.

For example, like the system 100 of FIG. 1, the system 300 of FIG. 3 includes the user 102, the audio 104a received by the microphone 106a, the first computing device 118a associated with the microphone 106a, the audio 104b received by the microphone 106b, the second computing device 118b associated with the second microphone 106b, the audio signal 108a generated by the first microphone 106a, and the second audio signal 108b generated by the second microphone 106b.

In addition, in the system 300 of FIG. 3, a first authentication state 302a and a first application state 304a are associated with the first computing device 118a. The authentication state 302a may, for example, contain data representing a state of authentication of the user 102 in relation to the device 118a, such as a binary state indicating whether or not the user 102 is authenticated to the device 118a. The authentication state 302a may indicate, for example, whether the user 102 is authenticated to the server 116 via the device 118a, such as via a client application executing on the device 118a and in communication with the server 116.

The first application state 304a may, for example, contain data representing a state of an application executing on the device 118a, such as a state of a client application executing on the device 118a and in communication with the server 116. Such a client application may, for example, be the same client application whose authentication state is represented by the authentication state 302a. The application state 304a may represent any state of the corresponding application, such as a state of a user interface of the application and/or a state indicating data that the user 102 currently is interacting with via the application (e.g., a patient chart).

Similarly, a second authentication state 302b and a second application state 304b are associated with the second computing device 118b. The authentication state 302b may, for example, contain data representing a state of authentication of the user 102 in relation to the device 118b, such as a binary state indicating whether or not the user 102 is authenticated to the device 118b. The authentication state 302b may indicate, for example, whether the user 102 is authenticated to the server 116 via the device 118b, such as via a client application executing on the device 118b and in communication with the server 116.

The second application state 304 may, for example, contain data representing a state of an application executing on the device 118b, such as a state of a client application executing on the device 118b and in communication with the server 116. Such a client application may, for example, be the same client application whose authentication state is represented by the authentication state 302b. The application state 304a may represent any state of the corresponding application.

The first authentication state 302a and first application state 304a may be associated with the first computing device 118a in any of a variety of ways, such as by being stored on the first computing device 118a or by containing data identifying any one or more of the following: the computing device 118a, an application executing on the computing device 118a, or the user 102. Similarly, the second authentication state 304a and second application state 304b may be associated with the second computing device 118b in any of a variety of ways, such as by being stored on the second computing device 118b or by containing data identifying any one or more of the following: the computing device 118b, an application executing on the computing device 118b, or the user 102.

The system 300 may also include location data 306 associated with the computing device 118b. Such location data 306 may represent any kind of location of the computing device 118b in any of a variety of ways, such as Global Positioning System (GPS) coordinates, Wifi Positioning System (WPS) coordinates, an IP address, or any combination thereof The location data 306 may be associated with the second computing device 118b in any of a variety of ways, such as by being stored on the second computing device 118b or by containing data identifying the computing device 118b.

Any of the authentication states 302a-b, application states 304a-b, and location data 306 may be updated over time to reflect changes in the corresponding authentication states, application states, and location, respectively.

The system 300 and method 400 may effectively merge the states (e.g., authentication states 302a-b and/or application states 304a-b) of the computing devices 118a and 118b by correlating sensor inputs associated with the computing devices 118a and 118b (e.g., audio signals 108a and 108b). Such merging of states may be performed, for example, as follows.

As in the method 200 of FIG. 2, in the method 400 of FIG. 4, the microphone 106a may capture first audio 104a (e.g., speech of the user 102), and produce as output the audio signal 108a representing the audio 104a (FIG. 4, operation 202). The microphone 106b may capture second audio 104b (e.g., speech of the user 102), and produce as output the audio signal 108b representing the audio 104b (FIG. 4, operation 404). The correlation module 110 may perform correlation on the audio signal 108a and the audio signal 108b to produce correlation output 112 representing the result of the correlation (FIG. 2, operation 206).

A correlation module 310 may determine whether the first and second audio 104a-b positively correlate with each other and produce correlation output 312 representing the results of such correlation (FIG. 4, operation 408). If the first and second audio 104a-b do positively correlate with each other, then a state merging module 314 may merge the state of the first and computing devices 118a-b to produce a merged state 316 in any of a variety of ways, such as one or more of the following (FIG. 4, operation 410):
If the user 102 is already authenticated at one of the computing devices 118a-b (e.g., as indicated by the corresponding one of the authentication states 302a-b), then the method 400 may authenticate the user 102 at the other one of the computing devices 118a-b. For example, the existing authentication of the user 102 at one of the computing devices 118a-b (e.g., login of the user 102 to an account associated with the server 116) may be extended to the user 102 at the other one of the computing devices 118a-b (e.g., by automatically logging the user 102 in to the same account associated with the server 116 at the other one of the computing devices 118a-b).
If the user 102 is already authenticated at one of the computing devices 118a-b (e.g., as indicated by the corresponding one of the authentication states 302a-b), then the method 400 may apply some or all of the application state (e.g., application state 304a or 304b) from the computing device at which the user 102 is authenticated to the other one of the computing devices 118a-b. For example, if the user 102 is logged into a particular Electronic Medical Record (EMR) on computing device 118a and has selected a particular patient, then the method 400 may select the patient ID of that patient as the context for the user 102's interaction with the other computing device 118b. As a particular example, if the user 102 says “order lisinopril 20 mg” and this speech 104a is captured by the microphone 106a associated with computing device 118a, then the application state 302b of the other computing device 118b may be used to identify a particular patient for which the medication should be ordered, even though the user 102's speech did not identify this patient.
The method 400 may apply a change in the application state associated with one of the computing devices 118a-b to the application state of the other one of the computing devices 118a-b. For example, if the user 102 has selected a first patient on computing device 118b and then selects a second patient on computing device 118b, then the method 400 may change the application state 304a of computing device 118a to indicate that the second patient has been selected by the user 102.
The method 400 may use the two audio streams 104a and 104b in any of a variety of ways to improve the functionality of the system 300 in comparison to the functionality that would be achieved using either of the audio streams 104a and 104b individually. For example, in a dialog between a patient and physician, the microphone 106b may be used entirely or primarily to capture the physician's voice, the microphone 106a may be used entirely or primarily to capture the patient's voice. As another example, the audio signals 108a and 108b may be used to determine the identity of the user 102 with higher reliability than by using either of the audio signals 108a-b individually.

Although only two computing devices 118a-b are shown in FIG. 3 for ease of illustration, the system 300 may include any number of computing devices having the same or similar properties as computing devices 118a-b. For example, each such computing device may have its own associated authentication state, application state, and/or location data. The authentication state associated with a particular computing device may, for example, indicate which user is currently authenticated to that computing device. As described above, the authentication state associated with a particular computing device may be stored in any of a variety of ways. For example, in one embodiment, a registration server stores the authentication states associated with the computing devices in the system 300 (e.g., computing devices 118a-b). When a stationary microphone in the system 300 receives audio, a speaker identification may process the output of that stationary microphone to identify one or more likely speakers of that audio and provide the identities of such users to the registration server. The registration server may then generate a list of computing devices (e.g., wearable devices) at which the identified users currently are authenticated. The correlation module 300 may then perform correlation, as described above in connection with operations 206 and 406, between the audio received from the stationary microphone and audio received from each of the computing devices identified by the registration server.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention use the correlation module 110 and authentication module 114 to correlate audio signals 108a and 108b with each other and to automatically authenticate the user 102 to the server 116 in response to determining that the audio signals 108a-b positively correlate with each other. These are functions which are inherently computer-implemented and which could not be performed by a human.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

One embodiment of the present invention is directed to a method performed by at least one computer processor executing computer program instructions stored on at least one non-transitory computer-readable medium. The method includes receiving, at a correlation module, a first audio signal from a first device, the first device being associated with a first computing device; receiving, at the correlation module, a second audio signal from a second device, the second device being associated with a second computing device; at the correlation module, correlating the first audio signal and the second audio signal to produce correlation output; determining whether the correlation output satisfies a positive correlation criterion; and, in response to determining that the correlation output satisfies the positive correlation criterion: (1) identifying a user associated with the second audio signal; and (2) automatically authenticating the user associated with the second audio signal with a service via the second computing device.

Automatically authenticating the user may include: identifying a user associated with the first audio signal; determining that the user associated with the second audio signal is authenticated with the service via the first computing device; and automatically authenticating the user associated with the second audio signal with the service via the second computing device. The user associated with the second audio signal may be authenticated with the service via the first computing device using particular credentials, and automatically authenticating the user associated with the second audio signal with the service via the second computing device may include automatically authenticating the user associated with the second audio signal with the service via the second computing device using the particular credentials.

Correlating the first audio signal and the second audio signal may include determining whether the first audio signal and the second audio signal both represent speech of a particular person. Correlating the first audio signal and the second audio signal may include determining whether the first audio signal represents first speech of the particular person at a first time, and determining whether the second audio signal represents the first speech of the particular person at the first time.

Correlating the first audio signal and the second audio signal may include performing mathematical cross-correlation on the first audio signal and the second audio signal. Correlating the first audio signal and the second audio signal may include comparing at least one feature derived from the first audio signal with at least one feature derived from the second audio signal. Correlating the first audio signal and the second audio signal may include applying a deep neural network to the first audio signal and the second audio signal.

The method may further include: before receiving the first audio signal, determining that the first audio signal contains speech representing a predetermined cue phrase; and in response to determining that the first audio signal contains speech representing the predetermined cue phrase, providing at least part of the first audio signal to the correlation module.

The method may further include: after determining that the first audio signal contains speech representing the predetermined cue phrase, identifying a voiceprint of the user associated with the second audio signal; and correlating the voiceprint with the second audio signal.

What is claimed is:

1. A method performed by at least one computer processor executing computer program instructions stored on at least one non-transitory computer-readable medium, the method comprising:
receiving, at a correlation module, a first audio signal from a first device, the first device being associated with a first computing device;
receiving, at the correlation module, a second audio signal from a second device, the second device being associated with a second computing device;
at the correlation module, correlating the first audio signal and the second audio signal to produce correlation output;
determining whether the correlation output satisfies a positive correlation criterion;
in response to determining that the correlation output satisfies the positive correlation criterion:
identifying a user associated with the second audio signal; and
automatically authenticating the user associated with the second audio signal with a service via the second computing device.

2. The method of claim 1, wherein automatically authenticating the user comprises:
identifying a user associated with the first audio signal;
determining that the user associated with the first audio signal is authenticated with the service via the first computing device; and
automatically authenticating the user associated with the second audio signal with the service via the second computing device.

3. The method of claim 2, wherein the user associated with the second audio signal is authenticated with the service via the first computing device using particular credentials, and
wherein automatically authenticating the user associated with the second audio signal with the service via the second computing device comprises automatically authenticating the user associated with the second audio signal with the service via the second computing device using the particular credentials.

4. The method of claim 1, wherein correlating the first audio signal and the second audio signal comprises determining whether the first audio signal and the second audio signal both represent speech of a particular person.

5. The method of claim 4, wherein correlating the first audio signal and the second audio signal comprises determining whether the first audio signal represents first speech of the particular person at a first time, and determining whether the second audio signal represents the first speech of the particular person at the first time.

6. The method of claim 1, wherein correlating the first audio signal and the second audio signal comprises performing mathematical cross-correlation on the first audio signal and the second audio signal.

7. The method of claim 1, wherein correlating the first audio signal and the second audio signal comprises comparing at least one feature derived from the first audio signal with at least one feature derived from the second audio signal.

8. The method of claim 1, wherein correlating the first audio signal and the second audio signal comprises applying a deep neural network to the first audio signal and the second audio signal.

9. The method of claim 1, further comprising:
before receiving the first audio signal, determining that the first audio signal contains speech representing a predetermined cue phrase; and
in response to determining that the first audio signal contains speech representing the predetermined cue phrase, providing at least part of the first audio signal to the correlation module.

10. The method of claim 1, further comprising:
after determining that the first audio signal contains speech representing the predetermined cue phrase, identifying a voiceprint of the user associated with the second audio signal; and
correlating the voiceprint with the second audio signal.

11. A system comprising at least one non-transitory computer-readable medium having computer program instructions stored thereon, the computer program instructions being executable by at least one computer processor to perform a method, the method comprising:
receiving, at a correlation module, a first audio signal from a first device, the first device being associated with a first computing device;
receiving, at the correlation module, a second audio signal from a second device, the second device being associated with a second computing device;
at the correlation module, correlating the first audio signal and the second audio signal to produce correlation output;
determining whether the correlation output satisfies a positive correlation criterion;
in response to determining that the correlation output satisfies the positive correlation criterion:
identifying a user associated with the second audio signal; and
automatically authenticating the user associated with the second audio signal with a service via the second computing device.

12. The system of claim 11, wherein automatically authenticating the user comprises:
identifying a user associated with the first audio signal;
determining that the user associated with the first audio signal is authenticated with the service via the first computing device; and
automatically authenticating the user associated with the second audio signal with the service via the second computing device.

13. The system of claim 12, wherein the user associated with the second audio signal is authenticated with the service via the first computing device using particular credentials, and
wherein automatically authenticating the user associated with the second audio signal with the service via the second computing device comprises automatically authenticating the user associated with the second audio signal with the service via the second computing device using the particular credentials.

14. The system of claim 11, wherein correlating the first audio signal and the second audio signal comprises determining whether the first audio signal and the second audio signal both represent speech of a particular person.

15. The system of claim 14, wherein correlating the first audio signal and the second audio signal comprises determining whether the first audio signal represents first speech of the particular person at a first time, and determining whether the second audio signal represents the first speech of the particular person at the first time.

16. The system of claim 11, wherein correlating the first audio signal and the second audio signal comprises performing mathematical cross-correlation on the first audio signal and the second audio signal.

17. The system of claim 11, wherein correlating the first audio signal and the second audio signal comprises comparing at least one feature derived from the first audio signal with at least one feature derived from the second audio signal.

18. The system of claim 11, wherein correlating the first audio signal and the second audio signal comprises applying a deep neural network to the first audio signal and the second audio signal.

19. The system of claim 11, wherein the method further comprises:
before receiving the first audio signal, determining that the first audio signal contains speech representing a predetermined cue phrase; and
in response to determining that the first audio signal contains speech representing the predetermined cue phrase, providing at least part of the first audio signal to the correlation module.

20. The system of claim 11, wherein the method further comprises:
after determining that the first audio signal contains speech representing the predetermined cue phrase, identifying a voiceprint of the user associated with the second audio signal; and
correlating the voiceprint with the second audio signal.
